(19) United States
(12) Patent Application Publication
(10) Pub. No.: US 2014/0146087 A1
(43) Pub. Date: May 29, 2014

(54) DISPLAY METHOD AND ELECTRICAL DEVICE

(71) Applicants: LENOVO (BEIJING) CO., LTD., Beijing (CN); BEIJING LENOVO SOFTWARE LTD., Beijing (CN)

(72) Inventor: Gaofeng LIN, Beijing (CN)

(73) Assignees: LENOVO (BEIJING) CO., LTD., Beijing (CN); BEIJING LENOVO SOFTWARE LTD., Beijing (CN)

(21) Appl. No.: 14/085,324

(22) Filed: Nov. 20, 2013

(30) Foreign Application Priority Data
Nov. 27, 2012 (CN) 201210492471.X

(51) Int. Cl. G09G 5/00

(52) U.S. Cl. CPC G09G 5/006
USPC 345/676

(57) ABSTRACT

The present invention discloses a display method for improving the usability of an electrical device. The method comprises acquiring a first operation; judging whether the first operation meets a preset condition; when it is determined by the judgment that the first operation meets the preset condition, adjusting the position of a first object comprised in the common region from a first position in the display unit to a second position in the display unit, the first position being different from the second position. The present invention also discloses an electrical device for implementing the method.

### CROSS REFERENCE TO RELATED APPLICATIONS

This application claims the benefit under 35 U.S.C. §119(a) of Chinese Patent Application No. 201210492471.X filed on Nov. 27, 2012, the entire disclosure of which is incorporated by reference herein in its entirety.

### TECHNICAL FIELD

The present invention relates to the field of a computer and an embedded device, in particular relates to a display method and an electrical device.

### BACKGROUND

In a “smart” era, people's most significant experience lies in the changes of senses and operations brought by a touch-screen, which makes a human-machine communication interface become more friendly, operations more convenient, and visibility more stately and refreshing. As a newly emerging technology, touch-screen technology is being widely used in various devices, such as mobile phones, cameras, computers, and industries have begun to use this technology on a large-scale. Some industrial fields, which are relatively unfamiliar to the public, have begun a large-scale use of touch-screen technology.

On many occasions, a relatively small-sized display-screen may have not been able to meet a need, for example, if it is required for multiple users to use the same electrical device simultaneously. In this case, if the screen of the electrical device is relatively small, it apparently cannot meet the needs of the users. Therefore, a large-sized display-screen has been developed, where a large-sized touch-screen is more employed.

During implementing the technical solution of an embodiment of the present application, the inventors have found that the prior art has at least the following technical problems:

Due to a relatively large size of a display-screen, if a user stands on one side of the display-screen and wants to operate an application located on the other side of the display-screen, he/she may not be able to conduct the operation because the application is unreachable. Thus, the usability of the electrical device is reduced, and its operational efficiency and user experience are affected.

### SUMMARY

Embodiments of the present invention provide a display method and an electrical device, for solving the technical problem of an inefficient usability of an electrical device in the prior art, and thereby achieving a technical effect of improving the usability of an electrical device.

A display method, which is applied to an electrical device, wherein the electrical device comprises a display unit having a common region displayed thereon, and the common region comprises therein at least one object, wherein each object can display a corresponding application after being triggered, the method comprising the steps as follows:

a first operation is acquired;

it is judged whether the first operation meets a preset condition;

when it is determined by the judgment that the first operation meets the preset condition, the position of a first object comprised in the common region is adjusted from a first position in the display unit to a second position in the display unit, the first position being different from the second position.

Preferably, the common region is an annular region; the shortest distance between any point on the edge of the common region and the edge of the display unit is no greater than a preset distance; the annular region has a first inner-boundary and a first outer-boundary.

Preferably, the annular region surrounds the inner-boundary of the display region of the display unit, and the annular region has a hidden state and a revealed state, wherein, the annular region can switch between the hidden state and the revealed state, according to a corresponding operation.

Preferably, the common region is a filled-region, and the filled-region has a second outer-boundary.

Preferably, said step that the position of a first object comprised in the common region is adjusted from a first position in the display unit to a second position in the display unit, comprises the position of the common region adjusted from a third position in the display unit to a fourth position in the display unit, which is different from the third position, so that the position of the first object located in the common region is changed from the first position to the second position.

Preferably, said step that the position of a first object comprised in the common region is adjusted from a first position in the display unit to a second position in the display unit, comprises the position of the first object adjusted from the first position to the second position, wherein the position of the common region is unchanged.

Preferably, said step that the position of the first object is adjusted from the first position to the second position, wherein the position of the common region is unchanged, comprises the position of the first object adjusted from a first position to a second position by rotating the annular region, with the position of the first object relative to the annular region being unchanged during the adjustment process.

Preferably, during the adjustment process of the position of the first object from a first position to a second position, the position of any object in the filled-region other than the first object is unchanged.

Preferably, after said step that the position of a first object comprised in the common region is adjusted from a first position in the display unit to a second position in the display unit, the method further comprises the steps as follows:

a second operation is acquired;

a first application corresponding to the first object is executed in response to the second operation, wherein, a first window corresponding to the first application is located in a region inside the first inner-boundary or in a region outside the first outer-boundary.

Preferably, after said step that the position of a first object comprised in the common region is adjusted from a first position in the display unit to a second position in the display unit, the method further comprises the steps as follows:

a second operation is acquired;

a first application corresponding to the first object is executed in response to the second operation, wherein, a first window corresponding to the first application is located in a region outside the second outer-boundary.

Preferably, said step that a first application corresponding to the first object is executed in response to the second operation, comprises:

a fifth position where the first window corresponding to the first application locates, is determined;

the first application is executed at the fifth position.

Preferably, the fifth position is located within a first range around the common region.

Preferably, after said step of determining a fifth position where the first window corresponding to the first application locates, the method further comprises the step of determining a positive direction of the first window.

Preferably, said step of determining a positive direction of the first window, comprises:

the display region of the display unit is divided into at least one sub-display region;

a first sub-display region, where the common region locates, is determined;

a positive direction of the first window is determined as a direction perpendicular to the edge of the display unit comprised in the first sub-display region.

Preferably, the first operation is an operation of dragging the common region or dragging the first object; or, the first operation is an operation of moving the common region, which is performed in any region on the display unit other than the common region, wherein the movement of the common region causes the first object to move to the second position corresponding to the first operation; or, the first operation is an operation of moving the common region, which is performed in any region on the display unit other than the common region, wherein the movement of the common region causes the first object to move in the direction of the second position corresponding to the first operation.

Preferably, after said step that the position of a first object comprised in the common region is adjusted from a first position in the display unit to a second position in the display unit, the method further comprises the steps as follows: if the second position is not located within the common region, then the first object within the common region is disabled from being displayed; or

if the second position is not located within the common region, then a first identifier is set to the first object within the common region, to indicate whether the first application corresponding to the first object is a reusable application.

An electrical device, wherein the electrical device comprises a display unit having a common region displayed thereon, and the common region comprises therein at least one object, wherein each object can display a corresponding application after being triggered, the electrical device further comprising:

an acquisition module used to acquire a first operation;

a judgment module used to judge whether the first operation meets a preset condition;

an adjustment module, which is used when it is determined by the judgment that the first operation meets the preset condition, to adjust the position of a first object comprised in the common region from a first position in the display unit to a second position in the display unit, the first position being different from the second position.

Preferably, the common region is an annular region; the shortest distance between any point on the edge of the common region and the edge of the display unit is no greater than a preset distance; the annular region has a first inner-boundary and a first outer-boundary.

Preferably, the annular region surrounds the inner-boundary of the display region of the display unit, and the annular region has a hidden state and a revealed state, wherein, the annular region can switch between the hidden state and the revealed state, according to a corresponding operation.

Preferably, the common region is a filled-region, and the filled-region has a second outer-boundary.

Preferably, the adjustment module is specifically used to adjust the position of the common region from a third position in the display unit to a fourth position in the display unit which is different from the third position, so that the position of the first object located in the common region is changed from the first position to the second position.

Preferably, the adjustment module is specifically used to adjust the position of the first object from the first position to the second position, wherein the position of the common region is unchanged.

Preferably, the adjustment module is specifically used to adjust the position of the first object from a first position to a second position by rotating the annular region, with the position of the first object relative to the annular region being unchanged during the adjustment process.

Preferably, during the adjustment process of the position of the first object from a first position to a second position, the position of any object in the filled-region other than the first object is unchanged.

Preferably, the electrical device further comprises an execution module;

the acquisition module is further used to acquire a second operation;

the execution module is used to execute a first application corresponding to the first object in response to the second operation, wherein, a first window corresponding to the first application is located in a region inside the first inner-boundary or in a region outside the first outer-boundary.

Preferably, the electrical device further comprises an execution module;

the acquisition module is further used to acquire a second operation;

the execution module is used to execute a first application corresponding to the first object in response to the second operation, wherein, a first window corresponding to the first application is located in a region outside the second outer-boundary.

Preferably, the execution module further comprises a determination sub-module and an execution sub-module;

the determination sub-module is used to determine a fifth position where the first window corresponding to the first application locates;

the execution sub-module is used to execute the first application at the fifth position.

Preferably, the fifth position is located within a first range around the common region.

Preferably, the determination sub-module is further used to determine a positive direction of the first window.

Preferably, the determination sub-module further comprises a division sub-module, a first determination sub-module and a second determination sub-module;

the division sub-module is used to divide the display region of the display unit into at least one sub-display region;

the first determination sub-module is used to determine a first sub-display region where the common region locates;

the second determination sub-module is used to determine a positive direction of the first window as a direction perpendicular to the edge of the display unit comprised in the first sub-display region.

Preferably, the first operation is an operation of dragging the common region or dragging the first object; or, the first operation is an operation of moving the common region, which is performed in any region on the display unit other than the common region, wherein the movement of the common region causes the first object to move to the second position corresponding to the first operation; or, the first operation is an operation of moving the common region, which is performed in any region on the display unit other than the common region, wherein the movement of the common region causes the first object to move in the direction of the second position corresponding to the first operation.

Preferably, the electrical device further comprises a disabling module and a setting module;

the disabling module is used if the second position is not located within the common region to disable the first object within the common region from being displayed;

the setting module is used if the second position is not located within the common region to set a first identifier to the first object within the common region and to indicate whether the first application corresponding to the first object is a reusable application.

The display method in the embodiment of the present invention may be applied to an electrical device, and the electrical device may comprise a display unit, which may have a common region displayed thereon. The common region may comprise therein at least one object, wherein each object can display a corresponding application after being triggered. The method may comprise the steps as follows: a first operation is acquired; it is judged whether the first operation meets a preset condition; when it is determined by the judgment that the first operation meets the preset condition, the position of a first object comprised in the common region is adjusted from a first position in the display unit to a second position in the display unit, the first position being different from the second position.

In the embodiment of the present invention, the common region may contain therein a plurality of objects, wherein each object may correspond to an application, and a user can adjust the position of the first object comprised in the common region by performing the first operation, and by adjusting the position of the first object, the user can operate the first object. Thus, it solves the technical problem of an inefficient usability of an electrical device in the prior art, and solves the problem that a user cannot operate the respective application due to the large size of a display-screen. With a simple operation, the position of the first object can be adjusted, and after the position adjustment, the first object can be operated. In this way, the operation efficiency is apparently increased, and the user experience is improved.

### BRIEF DESCRIPTION OF THE DRAWINGS

FIG. 1A is a main flowchart of the display method in an embodiment of the present invention;

FIG. 1B is a schematic diagram in an embodiment of the present invention, illustrating that the common region is an annular region;

FIG. 1C is a schematic diagram in an embodiment of the present invention, illustrating that the common region is a circular region;

FIG. 1D is a schematic diagram in an embodiment of the present invention, illustrating that the position of the common region is changed;

FIG. 1E is a schematic diagram in an embodiment of the present invention, illustrating that the position of the common region is unchanged;

FIG. 1F is a schematic diagram in an embodiment of the present invention, illustrating that the position of the common region is unchanged;

FIG. 2 is a detailed block diagram illustrating the electrical device in an embodiment of the present invention.

### DETAILED DESCRIPTION OF THE PREFERRED EMBODIMENTS

The display method in the embodiment of the present invention may be applied to an electrical device, the electrical device may comprise a display unit, which may have a common region displayed thereon, and the common region may comprise therein at least one object, wherein each object can display one application corresponding to the object after being triggered. The method may comprise the steps as follows: a first operation is acquired; it is judged whether the first operation meets a preset condition; when it is determined by the judgment that the first operation meets the preset condition, the position of a first object comprised in the common region is adjusted from a first position in the display unit to a second position in the display unit, the first position being different from the second position.

In the embodiment of the present invention, the common region may contain therein a plurality of objects, wherein each object may correspond to one application, and a user can adjust the position of the first object comprised in the common region by performing the first operation, and by adjusting the position of the first object, the user can operate the first object. Thus, it solves the technical problem of an inefficient usability of an electrical device in the prior art, and solves the problem that a user cannot operate the respective application due to the large size of a display-screen. With a simple operation, the position of the first object can be adjusted, and after the position adjustment, the first object can be operated. In this way, the operation efficiency is apparently increased, and the user experience is improved.

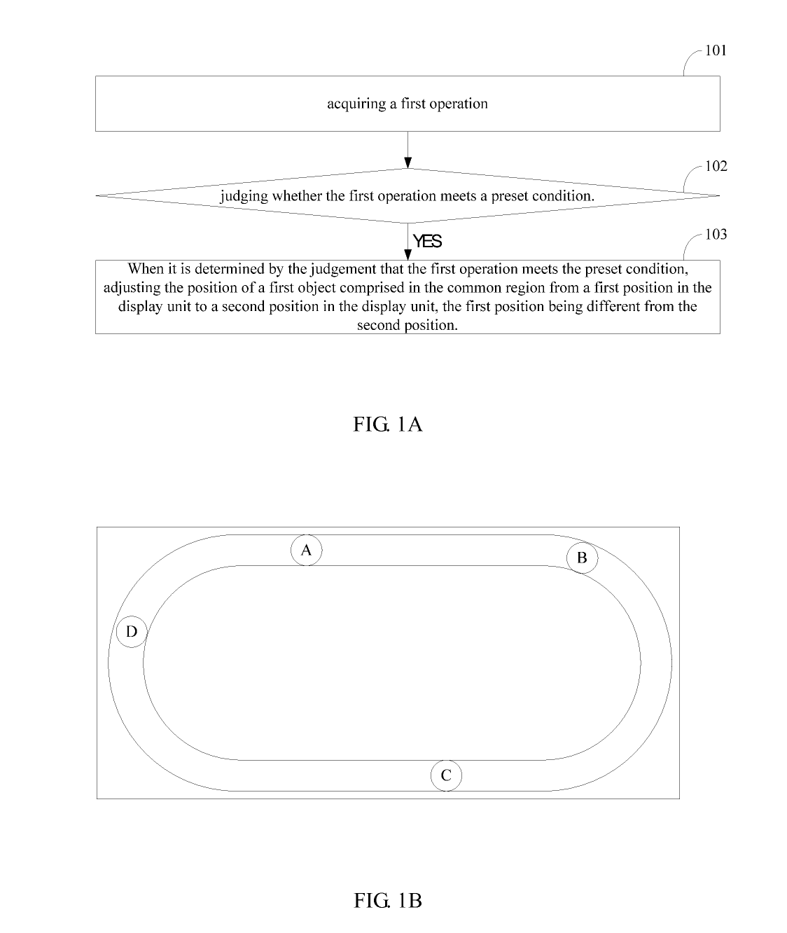

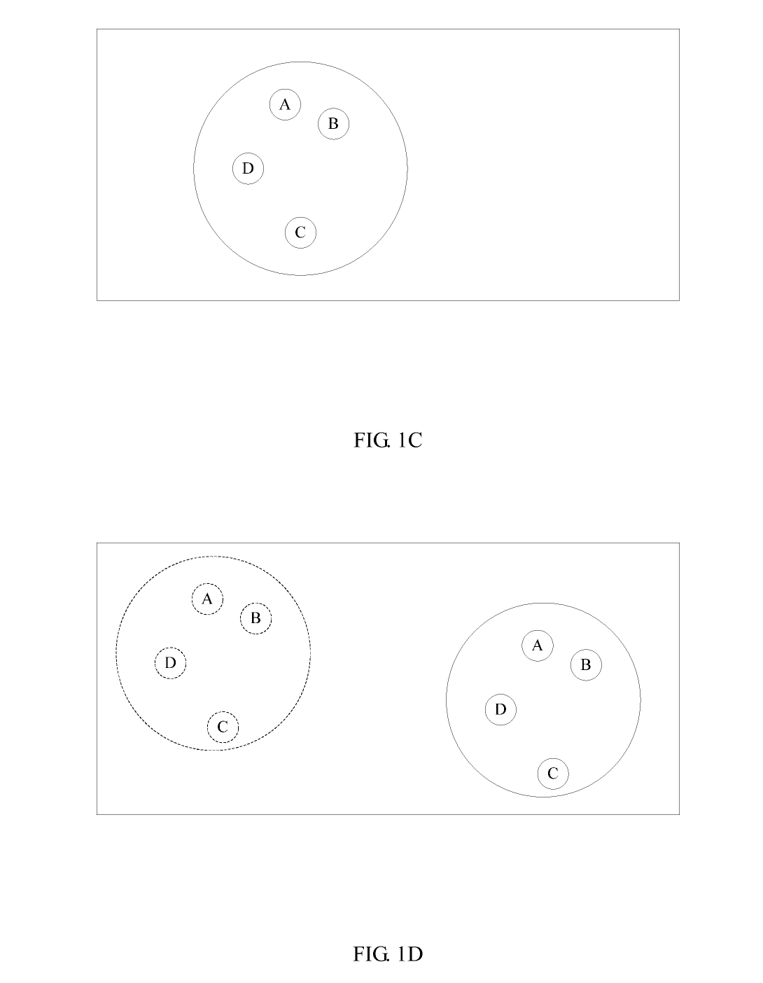

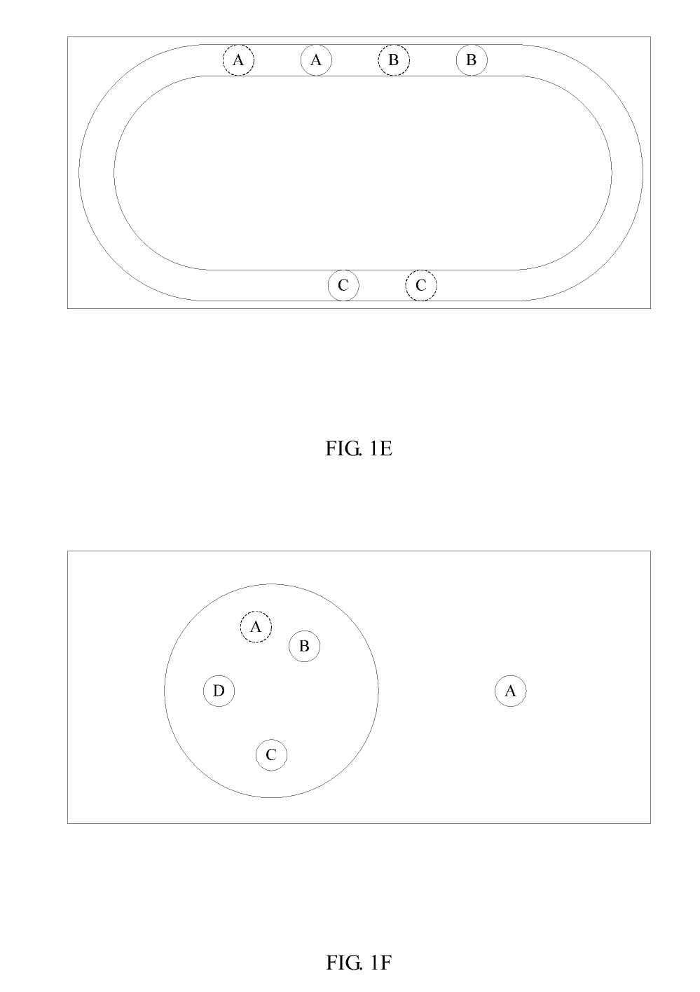

Referring to FIG. 1A, the display method in the embodiment of the present invention may be applied to an electrical device, and the electrical device may comprise a display unit, which may have a common region displayed thereon. The common region may comprise therein at least one object, wherein each object can display a corresponding application after being triggered. For example, each object can switch to foreground to display a corresponding application after the object is triggered. That is, each object may correspond to an application.

Optionally, the first object among the at least one object is not launched, initially, so a first application corresponding thereto is not displayed on the display unit. When the first object is launched, the first application may thus be displayed on the display unit, that is, the first application may be displayed in the foreground.

Optionally, the first object among the at least one object has been launched, but the first application corresponding thereto is executed in the background, and thus the first application is not displayed on the display unit. If the first object is triggered, then the first application may be switched from the background to the foreground for display, that is, it is switched from the background onto the display unit for display.

The main procedure of the method is as follows:

Step 101: a first operation is acquired.

Preferably, in this embodiment of the present invention, the electrical device may be a large-screen display device, for example, a large-screen PAD (Tablet Computer).

When a user needs to operate a respective object in the common region, but the location of the object may be inconvenient for the user to operate, then the user may need to adjust the location of the object.

In this case, the user may perform the first operation to the electrical device.

Optionally, in this embodiment of the present invention, the first operation may be an operation of dragging the common region or dragging the first object.

For example, the common region may comprise a first sub-region and a second sub-region; the first sub-region comprises therein at least one object, and the second sub-region may not have any object comprised therein. If it is required to move the common region, it may be implemented through a respective operation to the second sub-region. For example, it is possible to drag the second sub-region to implement the movement of the common region.

For example, in the embodiment of the present invention, the common region may be an annular region or a filled-region; and in this embodiment, it is described with an example that the common region is a filled-region and the filled-region is a circular region. The central area of the circular region may be the first sub-region; and the peripheral area in the circular region other than the first sub-region, may be the second sub-region. By dragging the second sub-region, it can implement the movement of the circular region.

Alternatively, if it is not required to move the entire common region, and instead, it is only required to move the position of a respective object in the common region, then it is also possible to only move the first sub-region, as long as the first sub-region after the movement is still located in the common region, or, it is also possible to only change the position of the respective object in the first sub-region, while the position of the first sub-region is unchanged.

For example, it is described hereinafter still with the example that the common region is the circular region.

If it is required to move the first sub-region, it may be implemented by dragging the first sub-region.

If it is only required to move the position of a respective object in the first sub-region, it may be implemented by dragging the respective object; or, it may be implemented by rotating the first sub-region around the circular center with a sliding operation, so that the position of the respective object on the display unit is changed.

Optionally, in this embodiment of the present invention, the first operation may be an operation of moving the common region, which is performed in any region on the display unit other than the common region, wherein the movement of the common region causes the first object to move to the second position corresponding to the first operation.

For example, the region on the display unit other than the common region may be referred to as a non-common region. In this embodiment of the present invention, the first operation may be an operation of moving the first object in the common region to the second position, which is performed in the non-common region.

For example, the first operation may be a double-click operation performed on the non-common region; the user performs the double-click operation at the fourth position, and the electrical device responses to the double-click operation, which may cause the common region to move from the third position on the display unit toward the fourth position on the display unit; and when the common region is moved toward the fourth position, it is equivalent that the first object is moved toward the second position.

In the embodiment of the present invention, the common region may be eventually moved to the fourth position, and the first object may be eventually moved to the second position.

Alternatively, the first operation also may be a triple-click operation performed on the non-common region; or, the first operation also may be a sliding operation with a particular trace, which is performed on the non-common region, and so forth.

Optionally, in this embodiment of the present invention, the first operation may be an operation of moving the common region, which is performed in any region on the display unit other than the common region, wherein the movement of the common region causes the first object to move in the direction of the second position corresponding to the first operation.

For example, the first operation may be an operation of moving the first object in the common region in the direction of the second position, which is performed in the non-common region.

For example, the first operation may be a double-click operation performed on the non-common region; the user performs the double-click operation at the fourth position, and the electrical device responses to the double-click operation, which may cause the common region to move from the third position on the display unit in the direction of the fourth position on the display unit; and when the common region is moved in the direction of the fourth position, it is equivalent that the first object is moved in the direction of the second position.

In this embodiment of the present invention, the common region may be eventually moved to the fourth position, may not be moved to the fourth position, or may be moved continually after being moved to the fourth position, as long as the moving direction of the common region is the direction of the fourth position.

That is, in this embodiment of the present invention, the first object may be eventually moved to the second position, may not be moved to the second position, or may be moved continually after being moved to the second position, as long as the moving direction of the first object is the direction of the second position.

Alternatively, the first operation also may be a triple-click operation performed on the non-common region; or, the first operation also may be a sliding operation with a particular trace, which is performed on the non-common region, and so forth.

Optionally, in this embodiment of the present invention, the first operation may be an operation of pressing a specific key. For example, the electrical device may be provided thereon with an appropriate physical key; if the user presses the physical key, it may be regarded that the user has performed the first operation.

In this embodiment of the present invention, if the first operation is an operation of pressing a specific physical key, then the electrical device may be provided with a plurality of physical keys on its periphery, wherein each physical key may correspond to a different function, or each physical key may correspond to a similar function.

In this embodiment of the present invention, the first operation may have various types, and the user may select one type to operate.

Step 102: it is judged whether the first operation meets a preset condition.

In this embodiment of the present invention, after the first operation is acquired, it may be judged whether the first operation meets the preset condition.

Optionally, after the first operation is acquired, it may be judged whether the first operation is an operation of dragging the common region or dragging the first object.

If it is determined by the judgment that the first operation is an operation of dragging the common region or dragging the first object, then it can be determined that the first operation meets the preset condition.

Optionally, after the first operation is acquired, it may be judged whether the first operation is an operation of moving the common region, which is performed in any region on the display unit other than the common region, wherein the movement of the common region causes the first object to move to the second position corresponding to the first operation.

If it is determined by the judgment that the first operation is an operation of moving the common region, which is performed in any region on the display unit other than the common region, wherein the movement of the common region causes the first object to move to the second position corresponding to the first operation, then it can be determined that the first operation meets the preset condition.

Optionally, after the first operation is acquired, it may be judged whether the first operation is an operation of moving the common region, which is performed in any region on the display unit other than the common region, wherein the movement of the common region causes the first object to move in the direction of the second position corresponding to the first operation.

If it is determined by the judgment that the first operation is an operation of moving the common region, which is performed in any region on the display unit other than the common region, wherein the movement of the common region causes the first object to move in the direction of the second position corresponding to the first operation, then it can be determined that the first operation meets the preset condition.

Optionally, after the first operation is acquired, it may be judged whether the first operation is an operation of pressing a specific key.

If it is determined by the judgment that the first operation is an operation of pressing a specific key, then it can be determined that the first operation meets the preset condition.

Step 103: when it is determined by the judgment that the first operation meets the preset condition, the position of a first object comprised in the common region is adjusted from a first position in the display unit to a second position in the display unit, the first position being different from the second position.

In this embodiment of the present invention, the common region may be an annular region For example, the annular region may be located on an edge of the display unit, and may surround the inner edge of the display region of the display unit, and may have a first inner-boundary and a first outer-boundary. For example, the first outer-boundary may be in contact with the edge of the display unit. Between the first outer-boundary and the first inner-boundary, there may be distributed at least one object; that is, the region from the first outer-boundary to the first inner-boundary is exactly the common region. The region outside the first outer-boundary and the region inside the first inner-boundary are the non-common region. Preferably, the shortest distance between any point on the edge of the annular region and the edge of the display unit, may not be greater than a preset distance. This ensures that the users who locate at any direction of the electrical device can perform an operation to the annular region. As shown in FIG. 1B, it is a schematic diagram illustrating that the common region is an annular region. In FIG. 1B, A, B, C, D represent four objects.

Preferably, the annular region may at least comprise a hidden state and a revealed state, and the annular region may switch between the hidden state and the revealed state, according to a corresponding operation received by the electrical device.

Optionally, if in a first predefined period of time, the electrical device does not receive any operation to the annular region, then the electrical device may control the annular region to enter into the hidden state from the revealed state, thereby facilitating the user for watching or operating the entire display region of the display unit.

Optionally, if the electrical device receives an operation from the user for setting the annular region to the hidden state, then it may control the annular region to enter into the hidden state from the revealed state. For example, the user may perform settings, so that the annular region is in the hidden state.

Optionally, if the electrical device receives an operation from the user for setting the annular region to the revealed state, then it may control the annular region to enter into the revealed state from the hidden state. For example, the user may perform settings, so that the annular region is in the revealed state.

For example, the user may set the annular region to the revealed state with specific gesture information, the user may set the annular region to the revealed state by pressing an appropriate physical key, or the user may set the annular region to the revealed state with a specific operation.

The common region is an annular region, which ensures that the users who locate around the electrical device all can perform an operation to the common region. By rotating the common region, the first object in the common region can be operated, which makes operations simple.

In this embodiment of the present invention, the common region also may be a filled-region; for example, the filled-region may be in a circular, square, or other shape, and the filled-region may have a second outer-boundary. The region inside the second outer-boundary is the common region, and the region outside the second outer-boundary is the non-common region.

In this embodiment of the present invention, for example, the display unit has a first region thereon; the first region comprises therein at least one object; the at least one object comprises a first object; the first object can display a first application corresponding thereto after being triggered, and the first application may correspond to a first window.

Optionally, when the first application is displayed, if the first window is located in the region outside the outer-boundary of the first region, and also may be located in the region inside the outer-boundary of the first region, then it can be indicated that the first region is a non-filled-region. For example the first region may be an annular region as described in the embodiment of the present invention. If the first region is an annular region as described in the embodiment of the present invention, then the outer-boundary of the first region may be the first outer-boundary of the annular region.

Optionally, when the first application is displayed, if the first window can only be located in the region outside the outer-boundary of the first region, but cannot be located in the region inside the outer-boundary of the first region, then it can be indicated that the first region is a filled-region. For example, the first region may be a filled-region as described in the embodiment of the present invention. If the first region is a filled-region as described in the embodiment of the present invention, then the outer-boundary of the first region may be the second outer-boundary of the filled-region.

Preferably, the non-filled-region may comprise at least two boundaries, for example, the annular region described in the embodiment of the present invention comprises the first outer-boundary and the first inner-boundary; the filled-region may only comprise one boundary, for example, the filled-region described in the embodiment of the present invention comprises the second outer-boundary.

In this embodiment of the present invention, if the common region is the filled-region, then the filled-region may comprise therein at least one object, and the filled-region may be located at any position on the display unit. As shown in FIG. 1C, it is a schematic diagram illustrating that the common region is the circular region. FIG. 1C is described with the example that the filled-region is a circular region. In FIG. 1C, A, B, C, D represent four objects.

The common region is a filled-region; therefore, when the user wants to adjust the position of the first object, he may only move the first object, and he also may move the common region, which can be selected and implemented according to specific circumstances. Moreover, if the user wants to operate a plurality of objects, it is more convenient by means of moving the common region.

In this embodiment of the present invention, if it is determined by the judgment that the first operation meets the preset condition, the position of the first object comprised in the common region may be adjusted from the first position in the display unit to the second position in the display unit. During the adjustment process of the position of the first object, if the common region is the filled-region, the position of the common region may be changed along with it, or the position of the common region may be unchanged; if the common region is the annular region, the position of the common region may be unchanged.

1. If the common region is the filled-region, then the position of the common region is also changed.

Optionally, the adjustment of the position of the first object from the first position to the second position, specifically may be the position of the common region is adjusted from a third position in the display unit to a fourth position in the display unit, so that the position of the first object located in the common region is changed from the first position to the second position. The third position is different from the fourth position. That is, the relative position between the common region and the first object is constant Therefore, if the position of the common region is adjusted, the position of the first object will also be changed along with it.

Specifically, the adjustment of the position of the common region from the third position to the fourth position, may be the first operation for changing the position of the common region is acquired, and the electrical device may respond to the first operation, so as to adjust the position of the common region from the third position to the fourth position.

As shown in FIG. 1D, it is a schematic diagram illustrating that the position of the common region is changed. The dotted line represents the common region locating at the third position before an adjustment. In the figure, A, B, C represent three objects, wherein A represents the first object. When the common region is located at the third position, the first object is in the first position. The solid line represents the common region locating at the fourth position after the adjustment. When the common region is located at the fourth position, the first object is in the second position. The arrow in FIG. 1D represents the direction of movement of the common region. FIG. 1D is described with the example that the filled-region is a circular region.

In this case, the first operation may be an operation of dragging the common region; or, the first operation may be an operation of moving the common region, which is performed in any region on the display unit other than the common region, wherein the movement of the common region causes the first object to move to the second position corresponding to the first operation; or the first operation may be an operation of moving the common region, which is performed in any region on the display unit other than the common region, wherein the movement of the common region causes the first object to move in the direction of the second position corresponding to the first operation.

2. The position of the common region is unchanged.

Optionally, if the common region is the annular region, the position of the first object can be adjusted from a first position to a second position by rotating the common region. During the adjustment process, the position of the first object relative to the annular region is not changed. If the annular region comprises therein a plurality of objects, then during the adjustment process, the relative position among the plurality of objects does not change, that is, the position of the first object relative to each of other objects is not changed. Moreover, during the adjustment process, the position of the annular region is also not changed.

As shown in FIG. 1E, it is a schematic diagram illustrating that the position of the common region is unchanged. The dotted line represents the first object locating at the first position before an adjustment. In the figure, A, B, C represent three objects, wherein A represents the first object. The solid line represents the first object locating at the second position after the adjustment, whereas the relative position of the three objects A, B, C is not changed, that is, the positions of the three objects A, B, C relative to the annular region are all not changed. FIG. 1E shows a schematic diagram illustrating that the second position is still in the common region.

Optionally, if the common region is the filled-region, then, the first operation for changing the position of the first object may be acquired, and the electrical device may respond to the first operation, so as to adjust the position of the first object from the first position to the second position. During the adjustment process, the position of the filled-region is not changed; moreover, if the circular region comprises therein a plurality of objects, then during the adjustment process, the position of any object in the filled-region other than the first object is also not changed.

As shown in FIG. 1F, it is a schematic diagram illustrating that the position of the common region is unchanged. The dotted line represents the first object locating at the first position before an adjustment. In the figure, A, B, C represent three objects, wherein A represents the first object. The solid line represents the first object locating at the second position after the adjustment, whereas the positions of the two objects B, C are not changed. FIG. 1F shows a schematic diagram illustrating that the second position is in the non-common region. FIG. 1F is described with the example that the filled-region is a circular region.

In this embodiment of the present invention, the first position is located within the common region, whereas after the adjustment, the first object is located at the second position, and the second position may be located within the common region, or may not be located within the common region. That is, the second position may be located within the common region, or the second position may also be located within the non-common region.

In this embodiment of the present invention, if the second position is not located within the common region, then, after the first object is adjusted to the second position, the first object may be disabled from being displayed in the common region; or, if the second position is not located within the common region, the first object may be continually displayed in the common region, and now, a first identifier may be set to the first object displayed in the common region, wherein the first identifier is used to indicate whether the first application corresponding to the first object is a reusable application.

For example, in the embodiment of the present invention, the first object may refer to an icon object, wherein each icon object may correspond to a respective application.

For example, if the first object is a “Word” icon object, then the first application is a “Word” application, and the “Word” application is a reusable application. Thus, if the first object is adjusted to the second position outside the common region, then the first identifier may be set to the “Word” icon object displayed in the common region, wherein the first identifier can indicate that the “Word” application is a reusable application.

In this embodiment of the present invention, after the position of the first object comprised in the common region is adjusted from the first position in the display unit to the second position in the display unit, the first application corresponding to the first object also may be executed.

Specifically, after the position of the first object is adjusted from the first position to the second position, the user may continue to perform a second operation to the first object, and the second operation may be an operation for executing the first application. For example, the second operation may be an operation of clicking the first object. The electrical device after acquiring the second operation, may respond to the second operation, so as to execute the first application. The first application corresponds to a first window.

In this embodiment of the present invention, if the common region is the annular region, then, the first window may be located in a region inside the first inner-boundary, i.e., the first window may be located inside the inner-boundary of the annular region, or the first window also may be located in a region outside the first outer-boundary, i.e., the first window may be located outside the outer-boundary of the annular region. The region inside the first inner-boundary and the region outside the first outer-boundary may be the non-common region, i.e., the annular region is the common region, and the first window may be located in the non-common region. Preferably, in this embodiment of the present invention, the annular region may surround the inner edge of the display region of the display unit, and the annular region may be close to the boundary of the display region, then the non-common region may all be the region inside the first inner-boundary, whereas the region outside the first outer-boundary may not be used for displaying.

In this embodiment of the present invention, if the common region is the filled-region, then the first window may be located outside the filled-region, i.e., the first window may be located in the region outside the second outer-boundary. That is, if the filled-region is the common region, then the first window may be located in the non-common region.

In this embodiment of the present invention, the step of responding to the second operation and executing of the first application, specifically may be firstly, a fifth position where the first window corresponding to the first application locates is determined; after the fifth position is determined, the first application is executed at the fifth position, then the first window can be located at the fifth position.

In this embodiment of the present invention, the fifth position may be located within a first range around the common region. Preferably, the fifth position may be in a close distance to the common region, because, if the common region is moved along as the first object is moved, then the common region after being moved should be not far from the location of the user, and now the first window is provided at the periphery of the common region. Thus, the first window also may be not far from the user, thereby facilitating the user for operating the first application.

In this embodiment of the present invention, after determination of the fifth position where the first window locates, a positive direction of the first window also may be determined.

In this embodiment of the present invention, the display region of the display unit may be initially divided into at least one sub-display region, and a first sub-display region where the common region locates may be firstly determined. In this embodiment of the present invention, the common regions may not locate exactly in one sub-display region. For example, the common region may locate in several sub-display regions at a same time; in this case, it may be determined which sub-display region comprises the largest area of the common region, then that sub-display region can be determined as the first sub-display region.

After the first sub-display region is determined, a positive direction of the first window may be determined as a direction perpendicular to the edge of the display unit comprised in the first sub-display region.

For example, the edge of the display unit comprised in the first sub-display region is the first edge of the display unit, and then a positive direction of the first window is a direction perpendicular to the first edge of the display unit.

In this embodiment of the present invention, after the positive direction of the first window is determined, the display may be performed. This ensures that the first window is directly opposite to the user, thereby facilitating the viewing of the user.

In this embodiment of the present invention, if the user completes using the first application, he/she may exit the first application. For example, a way for exiting the first application may be closing off the first window.

If the user exits the first application, then the first window may stop being displayed. Now, if the second position is in the non-common region, then the first object may automatically return to the first position; if the second position is in the common region, then the first object may automatically either return to the first position, or may remain in the second position. This can facilitate the use of other users.

For example, if the second position is in the non-common region, and after the adjustment of the first object to the second position, the first object is disabled from being displayed in the common region, then, after the user exits the first application, the first object may automatically return to the first position, and the first object may be continually displayed in the common region.

For example, if the second position is in the common region, then, after the adjustment of the first object to the second position, the first application is executed, and after the user exits the first application, the first object may automatically return to the first position, or the first object also may remain in the second position.

Below, the display method of the present invention will be explained with several specific embodiments, and the following embodiments mainly introduce several possible application scenarios of the method. It should be noted that, the embodiments of the present invention are merely used for explaining the present invention, but are not intended to limit the present invention. Any embodiment in accordance with the concept of the present invention should be within the scope of the present invention, and the skilled in the art will surely know how to make variations according to the concept of present invention.

### The First Embodiment

The electrical device is a large-sized integrated machine, and the machine is placed horizontally, which can be used simultaneously by multiple users.

When a user needs to operate a respective object in the common region, but the location of the object may be inconvenient for the user to operate, then the user may need to adjust the location of the object. In this case, the user may perform the first operation to the electrical device.

In this embodiment, the first operation may be an operation of dragging the common region or dragging the first object.

In this embodiment, after the first operation is acquired, it may be judged whether the first operation meets the preset condition.

In this embodiment, if it is determined by the judgment that the first operation is an operation of dragging the common region or dragging the first object, then it can be determined that the first operation meets the preset condition.

In this embodiment, the common region may be a filled-region. The embodiment of the present invention is described with the example that the filled-region is a circular region. If the common region is the circular region, then the circular region may comprise therein at least one object, and the circular region may be located at any position on the display unit.

In this embodiment, if it is determined by the judgment that the first operation meets the preset condition, the position of the first object comprised in the common region may be adjusted from the first position in the display unit to the second position in the display unit. In this embodiment, during the adjustment process of the position of the first object, the position of the common region may be changed along with it.

Specifically, it is possible that the position of the common region is adjusted from a third position in the display unit to a fourth position in the display unit, so that the position of the first object located in the common region is changed from the first position to the second position. The third position is different from the fourth position. That is, the relative position between the common region and the first object is constant, therefore, if the position of the common region is adjusted, the position of the first object will also be changed along with it.

In this embodiment, the first position is located within the common region, whereas after the adjustment, the first object is located at the second position, and the second position may continually locate in the common region.

In this embodiment, after the position of the first object is adjusted from the first position to the second position, the user may continue to perform a second operation to the first object, and the second operation may be an operation for executing the first application. For example, the second operation may be an operation of clicking the first object; the electrical device after acquiring the second operation, may respond to the second operation, so as to execute the first application. The first application corresponds to a first window.

In this embodiment, the common region is the circular region, then the first window may be located outside the circular region, i.e., the first window may be located in the region outside the second outer-boundary. That is, the circular region is the common region, and the first window may be located in the non-common region.

In this embodiment, the step of responding to the second operation and executing of the first application, specifically may be firstly, a fifth position where the first window corresponding to the first application locates, is determined; after the fifth position is determined, the first application is executed at the fifth position, then the first window can be located at the fifth position.

In this embodiment, the fifth position may be located within a first range around the common region. Preferably, the fifth position may be in a close distance to the common region.

Because, in this embodiment, the common region is moved along as the first object is moved, then the common region after being moved is not far from the location of the user, and now the first window is provided at the periphery of the common region. Thus, the first window also may be not far from the user, thereby facilitating the operation of the first application for the user.

In this embodiment, after determination of the fifth position where the first window locates, a positive direction of the first window also may be determined.

In this embodiment, the display region of the display unit may be initially divided into at least one sub-display region, and a first sub-display region where the common region locates may be firstly determined. In this embodiment of the present invention, the common regions may not locate exactly in one sub-display region. For example, the common region may locate in several sub-display regions at a same time; in this case, it may be determined which sub-display region comprises the largest area of the common region, then that sub-display region can be determined as the first sub-display region.

After the first sub-display region is determined, a positive direction of the first window may be determined as a direction perpendicular to the edge of the display unit comprised in the first sub-display region.

### The Second Embodiment

The electrical device is a large-sized integrated machine, and the large-sized integrated machine is placed horizontally, which can be used simultaneously by multiple users.

When a user needs to operate a respective object in the common region, but the location of the object may be inconvenient for the user to operate, then the user may need to adjust the location of the object. In this case, the user may perform the first operation to the electrical device.

In this embodiment, the first operation may be an operation of moving the common region, which is performed in any region on the display unit other than the common region, wherein the movement of the common region causes the first object to move to the second position corresponding to the first operation.

In this embodiment, after the first operation is acquired, it may be judged whether the first operation meets the preset condition.

In this embodiment, if it is determined by the judgment that the first operation is an operation of moving the common region, which is performed in any region on the display unit other than the common region, wherein the movement of the common region causes the first object to move to the second position corresponding to the first operation, then it can be determined that the first operation meets the preset condition.

In this embodiment, the common region may be an annular region. For example, the annular region may be located on an edge of the display unit, and may surround the inner edge of the display region of the display unit; for example, the outer-boundary of the annular region may be in contact with the edge of the display unit. Between the outer-boundary and the inner-boundary of the annular region, at least one object is distributed. The outer-boundary of the annular region may be referred to as a first outer-boundary, and the inner-boundary of the annular region may be referred to as a first inner-boundary. Preferably, the shortest distance between any point on the edge of the annular region and the edge of the display unit, may not be greater than a preset distance. This ensures that the users who locate at any direction of the electrical device can perform an operation to the annular region.

The annular region may at least comprise a hidden state and a revealed state, and the annular region may switch between the hidden state and the revealed state, according to a corresponding operation received by the electrical device.

When not in use, the annular region may be set into the hidden state; when in need of performing an operation to the annular region, the annular region may be switched from the hidden state to the revealed state by an appropriate operation.

In this embodiment, if it is determined by the judgment that the first operation meets the preset condition, the position of the first object comprised in the common region may be adjusted from the first position in the display unit to the second position in the display unit. In this embodiment, during the adjustment process of the position of the first object, the position of the common region may be unchanged.

Specifically, the position of the first object can be adjusted from a first position to a second position by rotating the common region. During the adjustment process, the position of the first object relative to the annular region is not changed. If the annular region comprises therein a plurality of objects, then during the adjustment process, the relative position among the plurality of objects does not change, that is, the position of the first object relative to each of other objects is not changed. Moreover, during the adjustment process, the position of the annular region is also not changed.

In this embodiment, the first position is located within the common region; whereas after the adjustment, the first object is located at the second position, and the second position is located inside the first inner-boundary, which indicates that the second position is not located within the common region, that is, the second position is in the non-common region.

In this embodiment, the second position is not located within the common region, then, after the first object is adjusted to the second position, the first object may be disabled from being displayed in the common region.

In this embodiment, after the position of the first object is adjusted from the first position to the second position, the user may continue to perform a second operation to the first object, and the second operation may be an operation for executing the first application. For example, the second operation may be an operation of clicking the first object; the electrical device after acquiring the second operation, may respond to the second operation, so as to execute the first application. The first application corresponds to a first window.

In this embodiment, the common region is the annular region, and then the first window may be located in the region inside the first inner-boundary. That is, the annular region is the common region, and the first window may be located in the non-common region. Preferably, if the common region is the annular region, then the non-common region is all located within the annular region, that is, the non-common region is all located inside the inner-boundary of the annular region.

In this embodiment, the step of responding to the second operation and executing of the first application, specifically may be firstly a fifth position where the first window corresponding to the first application locates is determined; after the fifth position is determined, the first application is executed at the fifth position, then the first window can be located at the fifth position.

### The Third Embodiment

The electrical device is a large-sized integrated machine, which can be used simultaneously by multiple users.

When a user needs to operate a respective object in the common region, but the location of the object may be inconvenient for the user to operate, then the user may need to adjust the location of the object. In this case, the user may perform the first operation to the electrical device.

In this embodiment, the first operation may be an operation of dragging the common region or dragging the first object.

In this embodiment, after the first operation is acquired, it may be judged whether the first operation meets the preset condition.

In this embodiment, if it is determined by the judgment that the first operation is an operation of dragging the common region or dragging the first object, then it can be determined that the first operation meets the preset condition.

In this embodiment, the common region may be a filled-region. The embodiment of the present invention is described with the example that the filled-region is a circular region, and the filled-region has a second outer-boundary. If the common region is the circular region, then the circular region may comprise therein of at least one object, and the circular region may be located at any position on the display unit.

In this embodiment, if it is determined by the judgment that the first operation meets the preset condition, the position of the first object comprised in the common region may be adjusted from the first position in the display unit to the second position in the display unit. In this embodiment, during the adjustment process of the position of the first object, the position of the common region is unchanged.

Specifically, the first operation for changing the position of the first object may be acquired, and the electrical device may respond to the first operation, so as to adjust the position of the first object from the first position to the second position. During the adjustment process, the position of the circular region is not changed. Moreover, if the circular region comprises therein a plurality of objects, then during the adjustment process, the position of any object in the circular region other than the first object is also not changed.

In this embodiment, the first position is located within the common region; whereas after the adjustment, the first object is located at the second position, the second position is located in the region outside the second outer-boundary, which indicates that the second position is not located within the common region, that is, the second position is in the non-common region.

In this embodiment, the second position is not located within the common region, and the first object may be continually displayed in the common region, and now, a first identifier may be set to the first object displayed in the common region, wherein the first identifier may be used to indicate whether the first application corresponding to the first object is a reusable application.

For example, in this embodiment, the first object may refer to an icon object, wherein each icon object may correspond to a respective application.

For example, if the first object is a “Word” icon object, then the first application is a “Word” application, and the “Word” application is a reusable application. Thus, if the first object is adjusted to the second position outside the common region, then the first identifier may be set to the “Word” icon object displayed in the common region. For example, the first identifier may be a flag bit, and in this case, the flag bit may be set as “1,” to indicate that the “Word” application is a reusable application. In addition, if the flag bit is set to “0,” which indicates that the “Word” application is a non-reusable application.

In this embodiment, after the position of the first object is adjusted from the first position to the second position, the user may continue to perform a second operation to the first object, and the second operation may be an operation for executing the first application. For example, the second operation may be an operation of clicking the first object. The electrical device after acquiring the second operation, may respond to the second operation, so as to execute the first application. The first application corresponds to a first window.

In this embodiment, the common region is the circular region, and then the first window may be located in the region outside the second outer-boundary. That is, the circular region is the common region, and the first window may be located in the non-common region.

In this embodiment, the step of responding to the second operation and executing of the first application, specifically may be firstly a fifth position where the first window corresponding to the first application locates is determined; after the fifth position is determined, the first application is executed at the fifth position, then the first window can be located at the fifth position.

In this embodiment, the fifth position may be located within a first range around the common region. Preferably, the fifth position may be in a close distance to the common region.

Because, in this embodiment, the common region is moved along as the first object is moved, then the common region after being moved is not far from the location of the user, and now the first window is provided at the periphery of the common region. Thus the first window also may be not far from the user, thereby facilitating the operation of the first application for the user.

In this embodiment, after determination of the fifth position where the first window locates, a positive direction of the first window also may be determined.

In this embodiment, the display region of the display unit may be initially divided into at least one sub-display region, and a first sub-display region where the common region locates may be firstly determined. In this embodiment of the present invention, the common regions may not locate exactly in one sub-display region. For example, the common region may be located in several sub-display regions at a same time; in this case, it may be determined which sub-display region comprises the largest area of the common region, then that sub-display region can be determined as the first sub-display region.

After the first sub-display region is determined, a positive direction of the first window may be determined as a direction perpendicular to the edge of the display unit comprised in the first sub-display region.

When the user completes using the first application, he/she may exit the first application.

If the user exits the first application, then the first window may stop being displayed. Now, if the second position is in the non-common region, then the first object may automatically return to the first position. If the second position is in the common region, then the first object either may automatically return to the first position or may remain in the second position. This can facilitate use of other users.

In this embodiment, the second position is in the non-common region, and then the first object may automatically return to the first position.

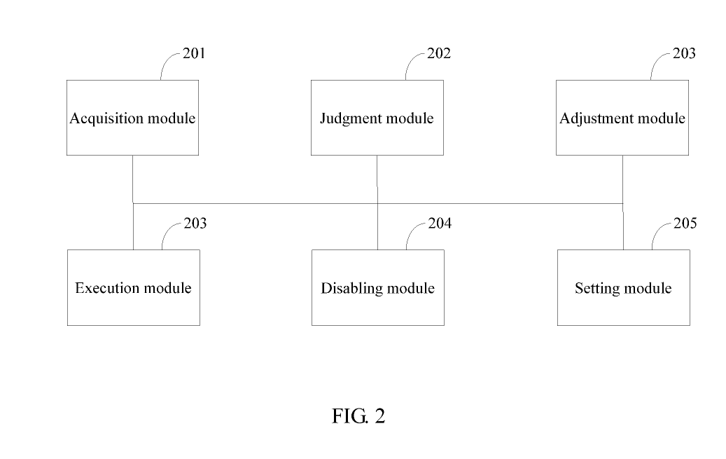

Referring to FIG. 2, the present invention also provides an electrical device; and the electrical device may comprise a display unit, which may have a common region displayed thereon, and the common region may comprise therein of at least one object, wherein each object can display a corresponding application after being triggered. The electrical device may further comprise an acquisition module 201, a judgment module 202, and an adjustment module 203.

Preferably, the electrical device may further comprise an execution module 204, a disabling module 205, and a setting module 206.

The acquisition module 201 may be used to acquire a first operation.

When the common region is the annular region, the acquisition module 201 may be further used to acquire a second operation.

When the common region is the filled-region, the acquisition module 201 may be further used to acquire a second operation.

The judgment module 202 may be used to judge whether the first operation meets a preset condition.

The adjustment module 203 may be used when it is determined by the judgment that the first operation meets the preset condition to adjust the position of a first object comprised in the common region from a first position in the display unit to a second position in the display unit, the first position being different from the second position.

In this embodiment of the present invention, the common region may be an annular region; the shortest distance between any point on the edge of the common region and the edge of the display unit, may not be greater than a preset distance; the annular region may have a first inner-boundary and a first outer-boundary.

In this embodiment of the present invention, the annular region may be in a hidden state.

In this embodiment of the present invention, the annular region may surround the inner-boundary of the display region of the display unit, and the annular region may have a hidden state and a revealed state, wherein, the annular region can switch between the hidden state and the revealed state, according to a corresponding operation.

In this embodiment of the present invention, the common region may be a filled-region, and the filled-region has a second outer-boundary.

The adjustment module 203 is specifically used to adjust the position of the common region from a third position in the display unit to a fourth position in the display unit, which is different from the third position, so that the position of the first object located in the common region is changed from the first position to the second position.

The adjustment module 203 is specifically used to adjust the position of the first object from a first position to a second position by rotating the annular region, with the position of the first object relative to the annular region being unchanged during the adjustment process.

In this embodiment of the present invention, during the adjustment process of the position of the first object from a first position to a second position, the position of any object in the filled-region other than the first object may be unchanged.

When the common region is the annular region, the execution module 204 may be used to execute a first application corresponding to the first object in response to the second operation; wherein, a first window corresponding to the first application is located in a region inside the first inner-boundary or in a region outside the first outer-boundary.

When the common region is the filled-region, the execution module 204 may be used to execute a first application corresponding to the first object in response to the second operation; wherein, a first window corresponding to the first application is located in a region outside the second outer-boundary.

The execution module 204 may further comprise a determination sub-module and an execution sub-module.

The determination sub-module may be used to determine a fifth position where the first window corresponding to the first application is located.

The determination sub-module may be further used to determine a positive direction of the first window.

The execution sub-module may be used to execute the first application at the fifth position.

In this embodiment of the present invention, the fifth position may be located within a first range around the common region.

In this embodiment of the present invention, the determination sub-module may further comprise a division sub-module, a first determination sub-module, and a second determination sub-module.

The division sub-module may be used to divide the display region of the display unit into at least one sub-display region.

The first determination sub-module may be used to determine a first sub-display region where the common region is located.

The second determination sub-module may be used to determine a positive direction of the first window as a direction perpendicular to the edge of the display unit comprised in the first sub-display region.

In this embodiment of the invention, the first operation is an operation of dragging the common region or dragging the first object; or, the first operation is an operation of moving the common region, which is performed in any region on the display unit other than the common region, wherein the movement of the common region causes the first object to move to the second position corresponding to the first operation; or, the first operation is an operation of moving the common region, which is performed in any region on the display unit other than the common region, wherein the movement of the common region causes the first object to move in the direction of the second position corresponding to the first operation.

The disabling module 205 may be used if the second position is not located within the common region to disable the first object within the common region from being displayed.

The setting module 206 may be used if the second position is not located within the common region to set a first identifier to the first object within the common region and to indicate whether the first application corresponding to the first object is a reusable application.

The display method in the embodiment of the present invention may be applied to an electrical device, the electrical device may comprise a display unit, which may have a common region displayed thereon, and the common region may comprise therein at least one object, wherein each object can display an application corresponding to the object after being triggered. The method may comprise the steps as follows: a first operation is acquired; it is judged whether the first operation meets a preset condition; when it is determined by the judgment that the first operation meets the preset condition, the position of a first object comprised in the common region is adjusted from a first position in the display unit to a second position in the display unit, the first position being different from the second position.

In the embodiment of the present invention, the common region may contain therein a plurality of objects, wherein each object may correspond to an application, and a user can adjust the position of the first object comprised in the common region by performing the first operation, and by adjusting the position of the first object, the user can operate the first object. Thus, it solves the technical problem of an inefficient usability of an electrical device in the prior art and also solves the problem that a user cannot operate the respective application due to the large size of a display-screen. With a simple operation, the position of the first object can be adjusted, and after the position adjustment, the first object can be operated. In this way, the operation efficiency is apparently increased, and the user experience is also improved.

As will be appreciated by the skilled in the art, the present invention may be embodied as a method, system, or computer program product. Accordingly, the present invention may take the form of an entirely hardware embodiment, an entirely software embodiment, or an embodiment combining software and hardware aspects. Furthermore, the present invention may take the form of a computer program product, which is embodied on computer-usable storage medium(s) (including, but not limited to, disk storage and optical memory, etc.) containing computer-usable program codes.

The present invention is described with reference to block diagrams and flowcharts of methods, devices (systems), and computer program products according to the embodiments of the invention. It should be understood that each procedure and/or block in the flowcharts and/or block diagrams, and the combinations of the procedure and/or block in the flowcharts and/or block diagrams, might be implemented by computer program instructions. These computer program instructions may be provided to a processor of a general purpose computer, special purpose computer, embedded processing machine or other programmable data processing apparatus to produce a machine, such that the instructions, which are executed by the processor of the computer or other programmable data processing apparatus, create means for implementing the functions specified in the procedure(s) of the flowcharts and/or the block(s) of the block diagrams.

These computer program instructions also may be stored in a computer-readable memory that can direct a computer or other programmable data processing apparatus to function in a particular manner, such that the instructions stored in the computer-readable memory produce an article of manufacture, including instruction means which implement the function specified in the procedure(s) of the flowcharts and/or the block(s) of the block diagrams.

The computer program instructions also may be loaded onto the computer or other programmable data processing apparatus to cause a series of operational steps to be performed on the computer or other programmable apparatus to produce a computer implemented process, so that the instructions, which are executed on the computer or other programmable apparatus, provide steps for implementing the functions specified in the procedure(s) of the flowcharts and/or the block(s) of the block diagrams.

Obviously, various modifications and variations can be made to the present invention by the skilled in the art without departing from the spirit and scope of the invention. Thus, in case that these modifications and variations fall in the scope of the claims of the present invention and their equivalents, then the present invention is also intended to encompass these modifications and variations.

What is claimed is:

1. A display method, which is applied to an electrical device, the electrical device including a display unit having a common region displayed thereon, and the common region having at least one object, each object displaying a corresponding application after being triggered, comprising:
acquiring a first operation; and
determining if the first operation meets a preset condition;
wherein the first operation meeting the preset condition in the determining step, adjusting the position of a first object in the common region from a first position in the display unit to a second position in the display unit, the first position being different from the second position.

2. The method of claim 1, wherein, the common region is an annular region; the shortest distance between any point on the edge of the common region and the edge of the display unit is not greater than a preset distance; the annular region has a first inner-boundary and a first outer-boundary.

3. The method of claim 2, wherein, the annular region surrounds the inner-boundary of the display region of the display unit, and the annular region has a hidden state and a revealed state; wherein, the annular region can switch between the hidden state and the revealed state, according to a corresponding operation.

4. The method of claim 1, wherein, the common region is a filled-region, and the filled-region has a second outer-boundary,
said step of adjusting the position of a first object comprised in the common region from a first position in the display unit to a second position in the display unit, comprises: adjusting the position of the common region from a third position in the display unit to a fourth position in the display unit which is different from the third position, so that the position of the first object located in the common region is changed from the first position to the second position.

5. The method of claim 2, wherein, said step of adjusting the position of a first object comprised in the common region from a first position in the display unit to a second position in the display unit, comprises: adjusting the position of the first object from the first position to the second position, wherein the position of the common region is unchanged.

6. The method of claim 5, wherein, said step of adjusting the position of the first object from the first position to the second position wherein the position of the common region is unchanged, comprises: adjusting the position of the first object from a first position to a second position by rotating the annular region, with the position of the first object relative to the annular region being unchanged during the adjustment process.

7. The method of claim 1, wherein, the common region is a filled-region, and the filled-region has a second outer-boundary,
during the adjustment process of the position of the first object from a first position to a second position, the position of any object in the filled-region other than the first object is unchanged.

8. The method of claim 2, wherein, after said step of adjusting the position of a first object comprised in the common region from a first position in the display unit to a second position in the display unit, the method further comprising the steps as follows:
acquiring a second operation;
executing a first application corresponding to the first object in response to the second operation; wherein, a first window corresponding to the first application is located in a region inside the first inner-boundary or in a region outside the first outer-boundary.

9. The method of claim 1, wherein, the common region is a filled-region, and the filled-region has a second outer-boundary,
after said step of adjusting the position of a first object comprised in the common region from a first position in the display unit to a second position in the display unit, the method further comprising the steps as follows:
acquiring a second operation;
executing a first application corresponding to the first object in response to the second operation; wherein, a first window corresponding to the first application is located in a region outside the second outer-boundary.

10. The method of claim 9, wherein, said step of executing a first application corresponding to the first object in response to the second operation, comprises:
determining a fifth position where the first window corresponding to the first application locates;
executing the first application at the fifth position.

11. The method of claim 10, wherein, after said step of determining a fifth position where the first window corresponding to the first application locates, the method further comprising the step of:
determining a positive direction of the first window;
diving the display region of the display unit into at least one sub-display region;
determining a first sub-display region where the common region locates; and
determining a positive direction of the first window as a direction perpendicular to the edge of the display unit comprised in the first sub-display region.

12. The method of claim 1, wherein, the first operation is an operation of dragging the common region or dragging the first object; or, the first operation is an operation of moving the common region, which is performed in any region on the display unit other than the common region, wherein the movement of the common region causes the first object to move to the second position corresponding to the first operation; or, the first operation is an operation of moving the common region, which is performed in any region on the display unit other than the common region, wherein the movement of the common region causes the first object to move in the direction of the second position corresponding to the first operation.

13. The method of claim 1, wherein, after said step of adjusting the position of a first object comprised in the common region from a first position in the display unit to a second position in the display unit, the method further comprising the steps as follows:
if the second position is not located within the common region, then the first object within the common region is disabled from being displayed; or
if the second position is not located within the common region, then a first identifier is set to the first object within the common region, to indicate whether the first application corresponding to the first object is a reusable application.

14. An electrical device, wherein, the electrical device comprising a display unit having a common region displayed thereon, and the common region comprising therein at least one object, wherein each object can display a corresponding application after being triggered, the electrical device further comprising:
an acquisition module used to acquire a first operation;
a determining module for determining if the first operation meets a preset condition; and
an adjustment module, when the first operation meets the preset condition in the determining step, for adjusting the position of a first object in the common region from a first position in the display unit to a second position in the display unit, the first position being different from the second position.

15. The electrical device of claim 14, wherein, the common region is a filled-region, and the filled-region has a second outer-boundary,
the adjustment module is specifically used: to adjust the position of the common region from a third position in the display unit to a fourth position in the display unit which is different from the third position, so that the position of the first object located in the common region is changed from the first position to the second position.

16. The electrical device of claim 14, wherein, the electrical device further comprises an execution module;
the acquisition module is further used to acquire a second operation;
the execution module is used to execute a first application corresponding to the first object in response to the second operation; wherein, a first window corresponding to the first application is located in a region inside the first inner-boundary or in a region outside the first outer-boundary.

17. The electrical device of claim 14, wherein, the common region is a filled-region, and the filled-region has a second outer-boundary,
the electrical device further comprises an execution module;
the acquisition module is further used to acquire a second operation;
the execution module is used to execute a first application corresponding to the first object in response to the second operation; wherein, a first window corresponding to the first application is located in a region outside the second outer-boundary.

18. The electrical device of claim 17, wherein, the execution module further comprises a determination sub-module and an execution sub-module;
the determination sub-module is used to determine a fifth position where the first window corresponding to the first application locates;
the execution sub-module is used to execute the first application at the fifth position.

19. The electrical device of claim 18, wherein, the determination sub-module is further used to determine a positive direction of the first window,
the determination sub-module further comprises a division sub-module, a first determination sub-module and a second determination sub-module;
the division sub-module is used to divide the display region of the display unit into at least one sub-display region;
the first determination sub-module is used to determine a first sub-display region where the common region locates;
the second determination sub-module is used to determine a positive direction of the first window as a direction perpendicular to the edge of the display unit comprised in the first sub-display region.

20. The electrical device of claim 14, wherein, the electrical device further comprises a disabling module and a setting module;
the disabling module is used: if the second position is not located within the common region, to disable the first object within the common region from being displayed;
the setting module is used: if the second position is not located within the common region, to set a first identifier to the first object within the common region, to indicate whether the first application corresponding to the first object is a reusable application.
